(19) United States
(12) Patent Application Publication
(10) Pub. No.: US 2023/0173433 A1
(43) Pub. Date: Jun. 8, 2023

(54) DRYER USING ELECTROCHEMICAL REGENERATED LIQUID DESICCANT

(71) Applicant: Palo Alto Research Center Incorporated, Palo Alto, CA (US)

(72) Inventors: Michael Benedict, Palo Alto, CA (US); Eugene S. Beh, Portola Valley, CA (US); Aaron Meles, Grand Rapids, MI (US)

(21) Appl. No.: 17/540,902

(22) Filed: Dec. 2, 2021

(51) Int. Cl. B01D 61/46; B01D 61/52; C02F 1/469; C02F 1/461

(52) U.S. Cl. CPC B01D 61/46; B01D 61/52; C02F 1/4693; C02F 1/46109; B01D 2313/345; C02F 2201/46115; C02F 2303/10

(57) ABSTRACT

A dryer system includes an electrodialytic regenerator that comprises a first channel that dilutes a first stream of liquid desiccant and a second channel that concentrates a second stream of the liquid desiccant. An air-liquid interface is in fluid communication with the second stream of the liquid desiccant and an input air stream and exposes the second stream of the liquid desiccant to the input air stream. The absorption of the water from the input air stream creates a dehumidified air stream. The system includes a heat transfer element in thermal communication with the air-liquid interface. The heat transfer element carries latent heat generated from the absorption of the water from the input air stream. The system includes a drying chamber coupled to receive the dehumidified air stream and the heat.

### TECHNICAL FIELD

This disclosure relates generally to systems that utilize electrochemical regeneration of a liquid desiccant for heat transfer.

### SUMMARY

Embodiments described herein are directed to a heat pump system using an electrodialysis apparatus. In one embodiment, the dryer system includes an electrodialytic regenerator that comprises a first channel that dilutes a first stream of liquid desiccant and a second channel that concentrates a second stream of the liquid desiccant. The first and second channels are separated by a central ionic exchange membrane. The electrodialytic regenerator includes a redox shuttle loop with first and second redox streams separated from the first and second channels by respective first and second outer ionic exchange membranes of a different type than the central ionic exchange membrane. The electrodialytic regenerator includes first and second electrodes that are operable to apply a voltage across the electrodialytic regenerator and cause the dilution of the first stream and the concentration of the second stream. The system includes an air-liquid interface in fluid communication with the second stream of the liquid desiccant and an input air stream. The air-liquid interface exposes the second stream of the liquid desiccant to the input air stream. The absorbing of water from the input air stream by the second stream creates a dehumidified air stream. The system includes a heat transfer element in thermal communication with the air-liquid interface. The heat transfer element carries latent heat generated from the absorption of the water from the input air stream. The system includes a drying chamber coupled to receive the dehumidified air stream and the heat.

Other embodiments are directed to a method that involves applying an external voltage between first and second electrodes of an electrodialytic regenerator. The regenerator has first and second channels separated by a central ionic exchange membrane. The first and second electrodes are separated from the first and second channels by respective first and second outer ionic exchange membranes of a different type than the central ionic exchange membrane. One or more solutions including one or more redox-active electrolyte materials are flowed over the first and second electrodes. The redox-active electrolyte materials reduce when in contact with the one of the first and second electrodes and oxidize when in contact with another of the first and second electrodes. In response to reduction and oxidation of the redox-active electrolyte materials, ions are transported across the first outer, second outer, and central ionic exchange membranes to move a salt of a liquid desiccant from the first channel to the second channel, the second channel producing a concentrated stream of the liquid desiccant. The concentrated stream is in contacted with an input air stream in an air contactor. The concentrated stream absorbs water from the input air stream to form a dehumidified air stream. The absorbing of water generates latent heat. The latent heat is carried from the air contactor to a drying chamber. The dehumidified air stream is input into the drying chamber.

The above summary is not intended to describe each disclosed embodiment or every implementation of the present disclosure. The figures and the detailed description below more particularly exemplify illustrative embodiments.

### BRIEF DESCRIPTION OF THE DRAWINGS

The discussion below refers to the following figures, wherein the same reference number may be used to identify the similar/same component in multiple figures. However, the use of a number to refer to a component in a given figure is not intended to limit the component in another figure labeled with the same number. The figures are not necessarily to scale.

FIGS. 1 and 2 are diagrams of a redox flow electrodialytic regenerators according to example embodiments;

FIG. 3 is a diagram of a dryer system using an electrodialytic regenerator according to an example embodiment;

FIG. 4. is a diagram of a dryer system using an electrodialytic regenerator and two air contactors according to an example embodiment; and

FIG. 5 is a flow diagram of a method in accordance with certain embodiments.

### DETAILED DESCRIPTION

The present disclosure relates to electrochemically regenerated liquid desiccant dehumidification systems. A liquid desiccant system may be used in, among other things, heating, ventilation, and air-conditioning (HVAC). Other applications, such as drying clothes, dehydrating food, etc., use equipment that operates on similar principles to HVAC equipment, but often under different operating conditions, e.g., temperature, relative humidity, etc. The systems described herein provide an efficient, thermodynamic approach to dehumidification for drying applications including a redox-assisted electrodialysis liquid desiccant regenerator that generates latent heat.

Liquid desiccants (e.g., aqueous solutions of lithium chloride, LiCl and/or other salt such as NaCl, LiBr, and CaCl₂)) will absorb moisture from air across an air-to-liquid interface (e.g., a membrane interface), which decreases concentration of the desiccant solute, resulting in a diluted output stream of liquid desiccant. In order to regenerate the liquid desiccation system in a loop, the diluted liquid desiccants can be efficiently re-concentrated using a redox-assisted regenerator. This type of regenerator, referred to as a shuttle-promoted electrolyte removal (SUPER) cell, can increase or decrease concentrations of solutes in solutions through the use of ionic transport membranes and a redox shuttle. The SUPER cell may also be referred to herein as a SUPER regenerator/stack, electrodialytic regenerator/cell/stack, electrochemical cell/stack, etc.

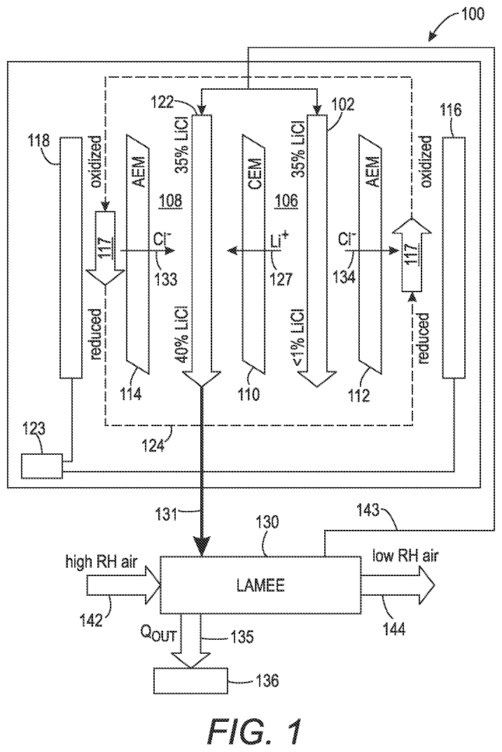

In FIG. 1, a diagram shows a SUPER cell 100 according to an example embodiment. The cell 100 includes two electrodes 116, 118, at least three ionic exchange membranes 110, 112, 114, and an energy supply 123. The first electrode 116 contacts a solution of a redox-active electrolyte material and is configured to have a first reversible redox reaction with the redox-active electrolyte material. The second electrode 118 contacts the redox-active electrolyte material in a second location and is configured to have a second reversible redox reaction with the redox-active electrolyte material that reverses the redox reaction performed at the first electrode. For purposes of simplicity, the first and second redox-active electrolyte solutions are shown in the FIG. 1 as a single redox shuttle solution 117 comprising the redox-active electrolyte materials.

Examples of a redox shuttle solution include 1,1′-bis((3-trimethylammonio) propyl)ferrocene ([BTMAP-Fc]²⁺) and 1,1′-bis((3-trimethylammonio)propyl)ferrocenium ([BTMAP-Fc]³⁺), or 1,1′-bis((3-dimethylammonio)propyl)ferrocene ([BTMEAP-Fc]²⁺) and 1,1′-bis((3-dimethylammonio)propyl)ferrocenium ([BTMEAP-Fc]³⁺), which are non-toxic, highly stable, ferrocene derivatives that have very rapid electrochemical kinetics and negligible membrane permeability, or ferrocyanide/ferricyanide ([Fe(CN)₆]⁴⁻/[Fe(CN)₆]³⁻). Additional details for example redox shuttle solutions can be found in commonly-owned U.S. patent application Ser. No. 17/390,600, filed Jul. 30, 2021 (Attorney docket number 20210171US01/0600.382US01), which is hereby incorporated by reference in its entirety.

The redox shuttle 117 is circulated between the two electrodes 116, 118 as shown by redox shuttle loop 124. When an electrical potential (voltage) is applied to each electrode 116, 118 by energy supply 123, the redox shuttle is oxidized at a first electrode (e.g., 116) and reduced at the opposite electrode (e.g., 118). The energy supply 123 may be any variety of direct current (DC) energy supply such as a battery, photovoltaic panel, galvanic cell, potentiostat, AC/DC power converter, etc., and the energy supply may be contained within the electrochemical cell 100 or be external and coupled to the cell 100. As the shuttle 117 circulates between the electrodes, the portions of the shuttle 117 are continuously alternating between the redox states. In other words, the electrical potential engenders faradaic reactions happening at the two different electrodes 116, 118 and the redox material undergoing the faradaic reactions is circulated from one electrode to the other and back again.

In certain embodiments, each electrode 116, 118 may contact separate redox-active solutions instead of the same redox shuttle solution 117 being flowed in a loop. The separate redox-active solutions may have the same redox-active electrolyte material or different redox-active electrolyte materials. When different redox-active solutions are used for the respective electrodes 116, 118, the energy supply may periodically reverse the potential supplied to the electrodes to restore the state of charge (e.g., the proportion of redox-active electrolyte material in each solution that is in the oxidized state compared to the reduced state) of each of the redox-active electrolyte material solutions.

Positioned between the electrodes 116, 118 are three ion exchange membranes, which alternate in the type of ion exchanged. For example, among three membranes, a center membrane 110 may be a cation type exchange membrane flanked by first and second outer membranes 112, 114 anion type exchange membranes, as is shown in FIG. 1. However, in other embodiments, the center membrane may be an anion exchange membrane and the outer membranes may be cation exchange membranes. The membranes 110, 112, 114 define channels (also referred to as chambers or reservoirs), in the electrochemical cell 100. As may be seen, a central membrane 110 and the outer membrane 112 define a first channel 106, which in this example is configured as a desalinate channel that decreases salt concentration in a fluid. The central membrane 110, in combination with the other outer membrane 114, also define a second channel 108, which in this example is configured as a salinate channel that increases salt concentration in a fluid.

The membranes 110, 112, 114 are ion-selective as well as water-permeable, are insoluble in organic solvents, and are inert (e.g., do not chemically change) in the reaction mixture and/or products. In certain embodiments, the membranes 110, 112, 114 are reinforced with a polymer mesh integrated into the membrane itself and in other embodiments, the membranes are not reinforced. It will be understood that this can be extended to additional membranes, e.g., 2N+1 membranes of alternating type that define respective N channels.

A first stream 102 flows through the first channel 106 of the electrochemical cell 100. The first stream 102 includes at least a solvent (water in this example) and a salt (LiCl in this example) dissolved in the solvent at a first salt concentration (about 35% by weight in this example) when it enters the first channel 106. A second stream 122 flows through the second channel 108 of the electrochemical cell 100. The second stream 122 has a second salt concentration (about 35% by weight) as it enters the first channel. The second salt concentration is the same as the first salt concentration in this example, although could be different. During an operational mode of the electrochemical cell 100, an electrical potential (e.g., <1.2 V) is applied to the electrodes 116, 118 and the first and second streams 102, 122 are moved (e.g., pumped) through the first and second channels 106, 108.

When an electrical potential is applied to the electrodes 116, 118, the redox shuttle 117 is oxidized at one electrode 116 and reduced at the other electrode 118, thereby driving salt ions 127 from the first stream 102 in the first channel 106 into the second stream 122 in the second channel 108. In particular, the redox shuttle 117 at the first electrode 116 accepts at least one ion 134 from the solution in the first channel 106. The redox shuttle 117 at the second electrode 118 drives at least one ion 133 into the second stream 122 in the second channel 108, and the charge is balanced by driving at least one ion 127, of opposite sign of charge to ions 133, 134, from the first stream 102 in the first channel 106 across the center membrane 110 into the second stream 122 in the second channel 108.

The result of the electrical potential being applied to the electrodes is that salt is moved from the first stream 102 to the second stream 122, such that the first stream 102 has a reduced concentration of salt (e.g., below a 10% threshold concentration) during the operation mode when exiting the first channel 106 and the second stream 122 increases in concentration of salt when exiting the second channel 108. The outputs of the first and second channels 106, 108 can be further processed by subsequent stages of a similar SUPER cell to achieve similar or increased levels of desalinization and salinization. Such a system may be used with various other salts, such as ionic salts that are soluble in the selected solvent. Example cations that can be present in the salts include, but are not limited to, hydronium, lithium, sodium, potassium, magnesium, calcium, aluminum, zinc, and iron. Example anions that can be present in the salts include, but are not limited to, chloride, bromide, iodide, halide oxyanions, sulfur oxyanions, phosphorous oxyanions, and nitrogen oxyanions.

As noted above, the SUPER cell 100 can be used to regenerate a liquid desiccant stream that flows through a liquid-to-air membrane energy exchanger (LAMEE) 130, which is shown in FIG. 1 coupled to the SUPER cell 100. In particular, the second, concentrated stream 122 is in fluid communication as an input 131 to the LAMEE 130. The LAMEE 130 receives an input air stream 142 with relatively high relative humidity (RH), and water vapor in the input air stream 142 is absorbed into the liquid desiccant. This results in the LAMEE 130 outputting an output air stream 144 with a relatively low RH. The water being absorbed in the liquid desiccant results in a diluted output stream 143 from the LAMEE 130, which can be fed back into the SUPER cell. In this case, the output of the first, diluted stream 102 can be discarded or used elsewhere.

The absorption of water into the liquid desiccant results in a temperature increase in the LAMEE 130, which is a well-known thermodynamic phenomenon (latent heat transfer) that occurs when water condenses from a gas to a liquid. In applications such as drying, this latent heat 135 can be applied to the material 136 being dried. The latent heat 135 can be combined with other sources of heat, such as heat provided by combustion, resistive heating, vapor compression heating, solar heating, etc.

The desiccant flow rate through the LAMEE 130 can affect temperatures and system energy consumption. A high flow rate of liquid desiccant has low concentration change between the input stream 131 and the output stream 143. This may require more energy to reconcentrate the input stream 131 via the SUPER cell, as regeneration requires more energy at higher concentrations. One the other hand, a high desiccant flow rate may provide less rejection of heat 135 from the LAMEE 130. A low flow rate of liquid desiccant through the LAMEE 130 increases the concentration change between the input stream 131 and the output stream 143. This can reduce the energy needed to reconcentrate the input stream 131 via the SUPER cell 100, and may increase the rejection of heat 135 from the LAMEE 130. Thus, for drying applications that aim to maximize heat and minimize energy consumed by the SUPER cell 100, a low flow rate through the LAMEE 130 is preferable.

Before discussing dryer configurations in greater detail, it will be understood that a liquid desiccant system as shown in FIG. 1 may employ more than one SUPER cell in order to improve efficiency. For example, changing concentration levels of the liquid desiccant solutions in smaller, discrete steps can minimize osmotic pressure differentials in each channel of the SUPER cells. Thus, in some embodiments, a SUPER liquid desiccant regenerator has two or more stages, each subsequent stage being configured to produce an output stream having a concentration of the liquid desiccant higher than the previous stage.

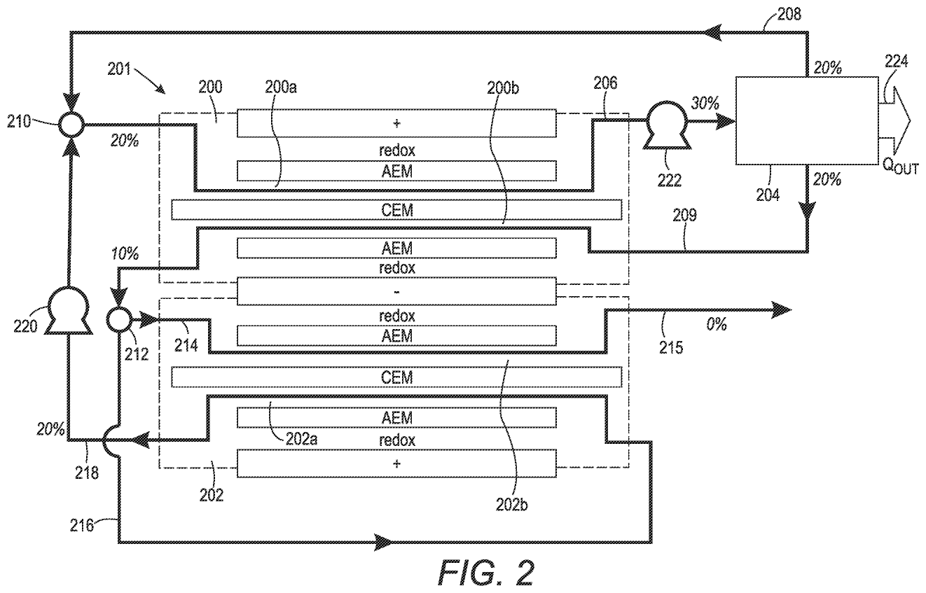

In FIG. 2, a diagram shows how a stack 201 of two SUPER cells 200, 202 can be coupled together into a two-stage regenerator to increase efficiency in a liquid desiccant regeneration system. A LAMEE 204 receives a concentrated stream 206 of liquid desiccant from the first SUPER cell 200. The concentration level of the stream 206 is about 30% here, although these are estimated values provided for the purposes of illustration and not limitation. The LAMEE 204 causes water from an air flow (not shown) to be absorbed in the liquid desiccant, resulting in output streams 208, 209 having a lower concentration of desiccant, around 20% in this example. Note that the streams 208, 209 are shown exiting the LAMEE 204 separately, however may be joined to a common fluid port within or outside of the LAMEE 204.

The output stream 208 is fed back into a salinization channel 200a of the first SUPER cell 200 via a fluid junction 210 (e.g., T-junction or manifold), where it is regenerated to the input concentration. The other output stream 209 is fed into a desalinization channel 200b of the first SUPER cell 200, where it is desalinized to around 10% concentration. This lower concentration solution is divided at fluid junction 212, which sends a first stream 214 through a desalinization channel 202b of the second SUPER cell 202, resulting in a discharge stream 215 of nearly pure water. In other cases, the discharge stream 215 may have low concentrations (e.g., <10%, <5%, <1%) of the liquid desiccant solutes. A second stream 216 of the lower concentration solution from junction 212 is sent into a salinization channel 202a of the second SUPER cell 202, where it comes out as an increased concentration stream 218 and is rejoined with LAMEE exit stream 208 at junction 210.

In this example the SUPER cell 202 forms a first stage, and the SUPER cell 200 forms a second stage. The subsequent, second stage produces an output stream having a concentration (30% in this example) of the liquid desiccant higher than the corresponding output stream of previous, first stage output. The corresponding output of the first stage is 20% in this example. Pumps 220, 222 are shown driving the flows of liquid desiccant, although the number and location of pumps can vary from what is shown here. Generally, one pump may be used for each SUPER cell that is used in a different stage of processing. Other pumps (not shown) may be used to drive the redox shuttle in the SUPER cells 200, 202. As with the arrangement shown in FIG. 1, the system shown in FIG. 2 incudes at least one heat transfer element for accepting heat 224 from the LAMEE 204 for purposes of drying.

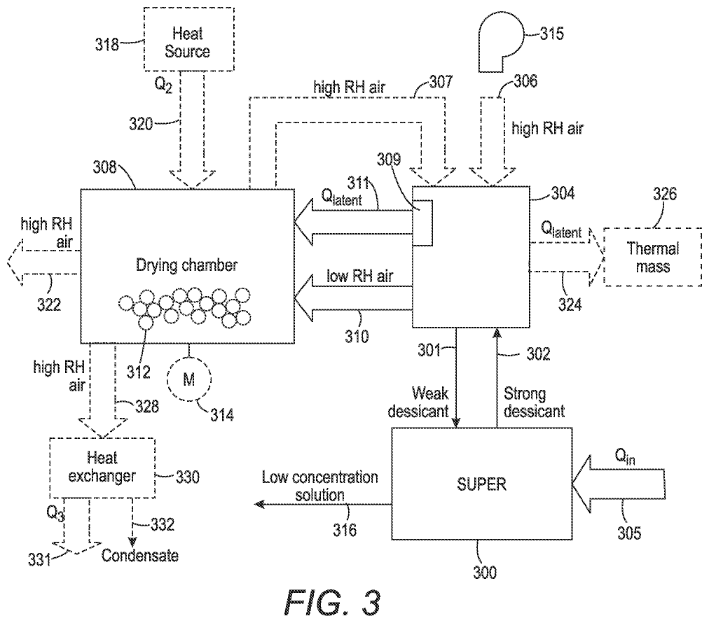

In FIG. 3, a block diagram shows a drying system using SUPER liquid desiccant regeneration according to an example embodiment. A SUPER regenerator 300 includes a stack of one or more cells that receives a weak desiccant stream 301 with a relatively low concentration of desiccant in solution and outputs a strong desiccant stream 302 with a relatively high concentration of desiccant in solution. The SUPER regenerator 300 regenerates the solution for a dehumidifying LAMEE 304. The electrochemical regeneration performed by the SUPER stack 300 with certain desiccants produces a cooling effect, as shown by absorption of heat 305.

At least one stream of humid air is input to the LAMEE 304, as indicated by air streams 306, 307. The streams 306, 307 may be naturally driven, e.g., convective flow, or may be forced flows under the influence of one or more blowers 315 or the like. The stream 306 may come from anywhere, e.g., ambient air. Stream 307 is recirculated from a drying chamber 308, which will be described in greater detail below. This may be incorporated in a ventless drying application, for example. The humid air stream(s) 306, 307 contact a liquid desiccant inside the LAMEE 304, absorbing moisture in the streams resulting in dehumidified air stream 310. The condensation of water vapor into the liquid desiccant results in latent heat 311 being output from the LAMEE 304.

The latent heat 311 is transferred to the drying chamber 308 via a heat transfer element 309 that is in thermal communication with the LAMEE 304. The heat transfer element 309 directly (e.g., via contact) or indirectly (e.g., via radiation) collects the latent heat 311 from the LAMEE 304. In one embodiment, the latent heat 311 can be mixed with the dehumidified air stream 310 as it is fed into the drying chamber 308. Generally, the drying chamber 308 is an enclosure, volume, channel, or the like in which a product 312 is exposed to dehumidified air for purposes or reducing water content on or in the product 312. This could involve outer surface drying (e.g., non-porous parts) or drying through a volume of the product 312 (e.g., clothing, food products, lumber, concrete, etc.). The latent heat 311 may be moved into the drying chamber 308 some other way than being mixed with the dehumidified air stream 310. For example, a heat pump (not shown) could be used to move the latent heat 311 from the LAMEE 304 to heat any combination of the drying chamber 308, the product within the drying chamber 308, or some other heat transfer device in the drying chamber 308 (e.g., a radiative heat emitter, conveyor belt, etc.). The heat could be transferred using one or more of convection, conduction, and radiation.

The drying chamber 308 may serve as a holding cell for the product 312, or the product 312 may be conveyed through the drying chamber 308, e.g., using a conveyor belt. Other movement may instead or in addition be imparted on the product, as represented by motor 314. For example, the product 312 may be tumbled, spun, agitated, etc., to increase airflow around the product and speed drying, for example. The motor 314 may be electrically or hydraulically powered, and in the latter case, may be incorporated into the fluid paths used by the LAMEE 304 and SUPER regenerator 300. For example, a low concentration stream exiting the SUPER regenerator 300 may be pressurized to drive the motor 314. Desiccant streams 301, 302 may be used for a similar purpose.

Air exiting the drying chamber 308 may be carried as one or more dryer output streams 307, 322, 328. As noted above, dryer output stream 307 is received from the drying chamber 308 and used to form at least part of the input air stream to the LAMEE 304 in a closed loop configuration. Alternatively, dryer output stream 322 from the drying chamber 308 may be released to the atmosphere. In yet another option, dryer output stream 328 is sent to a heat exchanger 330 to extract any unused energy (e.g., heat 331). The heat 331 could be directed elsewhere in the system, e.g., to heat the SUPER regenerator 300, combined with latent heat 311 of the LAMEE 304, etc. The heat exchanger 330 may produce liquid condensate 332, which could be combined with the low concentration solution 316 for further dilution. Note that any combination of air streams 307, 322, 328 could be used together, with each stream having some fixed or variable percentage of the total mass flow of air.

Depending on the product 312, the latent heat 311 provided from the LAMEE 304 alone may be sufficient. For example, when drying some food products, there may be an advantage in drying at low temperatures (e.g., less than 50° C.), which may not require much additional heat of the product is already at room temperature when entering the drying chamber 308. In other cases, such as clothes or dish washing, more heat may be needed than can be provided from the LAMEE 304, and an alternative heat source 318 may be used to provide additional heat 320. The alternative heat source 318 may generate the heat 320 using any combination of combustion, vapor compression, electricity (e.g., resistive or inductive heating), solar radiation, etc. The alternative heat source 318 may directly heat the drying chamber 308 or anything in the chamber 308 (e.g., via conduction) and/or may use convective or forced flow of heated gas (e.g., air, nitrogen, carbon dioxide).

In other embodiments, it may be possible to gain this extra heat from the SUPER regenerator 300 and LAMEE 304 without relying on an alternative heat source 318. For example, if the SUPER regenerator 300 and LAMEE 304 are run continuously (e.g., providing dehumidification for some other function such as air conditioning), then excess latent heat 324 may be transferred to a thermal mass 326, e.g., a well-insulated reservoir of liquid or other thermal storage media. Over a long period of time (e.g., hours, days) while the dryer system is idle, the excess heat 324 can cause a significant temperature rise in the thermal mass 326. As a result, the heated thermal mass 326 may provide sufficient heat for a drying operation, thereby reducing or eliminating the need for an alternative heat source 318.

The low concentration solution 316 may be safely discharged as waste, or may have low enough concentration of solutes to be safely re-used in a household or commercial facility. In some cases, there may be benefits in avoiding production of an output stream by the drying system. By removing the need to discharge water with trace desiccants, the installation of the system can be more flexible and efficient. Instead of a drain, the system can utilize a second air contactor to deal with the low concentration solution 316 processed by the SUPER regenerator 300.

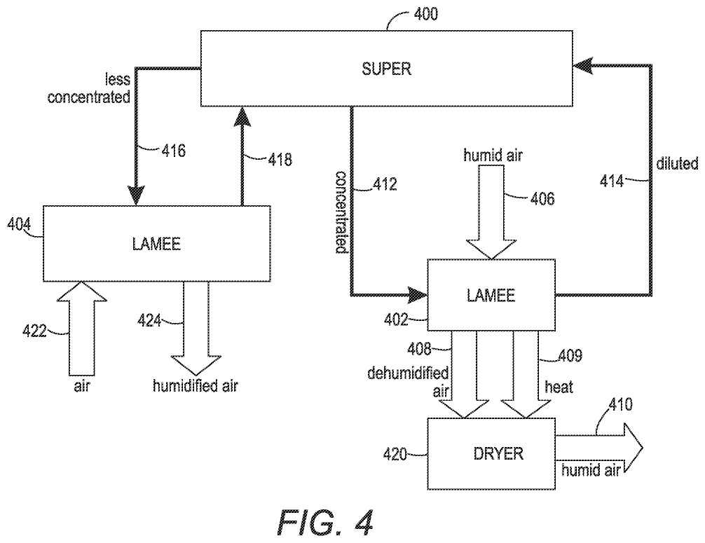

In FIG. 4, a block diagram illustrates a system utilizing a SUPER regenerator 400 in conjunction with two air contactors 402, 404. The regenerator 400 operates as described above in connection with FIGS. 1 and 2, unless otherwise described. The electrochemical regenerator 400 outputs a concentrated solution 412 of liquid desiccant (e.g., an aqueous salt solution) to a first LAMEE air contactor 402 (e.g., a membrane energy exchanger), which in this embodiment is a dehumidifying air contactor. The concentrated solution 412 of liquid desiccant may have a range of concentrations, depending upon the system design, from about 20-40%.

An air stream 406 is flowed over the concentrated solution of liquid desiccant in the LAMEE 402 either directly or via a membrane where water from the air stream is absorbed by the liquid desiccant stream. The air stream 406 may be outside (e.g., ambient) air, return air from an enclosed space (e.g., building) that the regenerator 400 is used to supply, exhaust air from the building, or a combination of these. The air stream 406 has a first water concentration. The water concentration of an air stream may refer to either the absolute or relative humidity of the air. After absorbing the water from the air 406, the liquid desiccant stream is diluted and the diluted solution stream 414 is output from the first air contactor 402. The diluted liquid desiccant stream 414 is then cycled back to the electrochemical regenerator 400 for regeneration (e.g., increasing concentration of liquid desiccant in the stream 414 as it flows through the regenerator 400).

The first air contactor 402 also outputs a dehumidified air stream 408 (e.g., having a lower relative humidity/lower water concentration than air stream 406) and latent heat 409. The dehumidified air stream 408 is input to a dryer system 420, which also directly or indirectly absorbs the heat 409. The dryer system 420 outputs humid air 410, which results from the dehumidified air stream 408 carrying away moisture from a product in the dryer system 420.

To keep the system supplied with the concentrated stream of liquid desiccant solution 412, the electrochemical regeneration system 400 regenerates the diluted liquid desiccant stream 414 received from the first LAMEE air contactor 402. As described above, the regenerator 400 outputs the concentrated stream 412 as well as a second, less concentrated stream 416. Output stream 416 is a diluted discharge stream has a concentration of liquid desiccant lower than that of stream 412, and in certain embodiments, output stream 416 has a concentration in a range of about 1-20%, and in some embodiments <10%. This second, less concentrated (e.g., diluted) discharge stream 416 is fed, directly or indirectly, to a second LAMEE air contactor 404, which in this embodiment is a humidifying air contactor. Similar to air contactor 402, air contactor 404 may include a membrane energy exchanger.

Air 422 is flowed over the diluted output stream 416 from the regenerator 400, either directly or via a membrane, where water from the output stream 416 is evaporated and absorbed by the air stream 422. The second air flow 422 may include outside air from the environment, or otherwise received from outside of the previously described dryer system components. The resulting humidified air is output from the second air contactor 404 as an output, humidified air stream 424 that is returned to the environment external to the components of the dryer system. The evaporation of water from the diluted output stream 416 results in a more concentrated liquid desiccant stream 418 that is then cycled back to the electrochemical regenerator 400 for further regeneration. The second air contactor liquid desiccant output stream 418 has a concentration of liquid desiccant higher than that of stream 416, and in certain embodiments, second air contactor output stream 418 has a concentration in a range of about 2-35% and in some embodiments >10%.

Flows of liquid desiccant solutions and multiple air streams are shown in FIG. 4. While each of these flows may occur simultaneously, the timing of various portions the system may also be individually controlled. For example, the air contactors 402, 404 and/or electrochemical regenerator 400 may be operated simultaneously, or in various combinations. The system may include storage containers, with or without bypass valves, at various positions throughout the system to store/contain diluted and/or regenerated solutions of liquid desiccant to take advantage of energy savings (e.g., to operate energy intensive portions of the system during off-peak or less expensive times). Other variations of multiple air contactor systems that may be incorporated into a drying system are shown in U.S. patent application Ser. No. 17/161,904 filed on Jan. 29, 2021 (attorney docket number 20200500US01/0600.000350US01) which is hereby incorporated by reference.

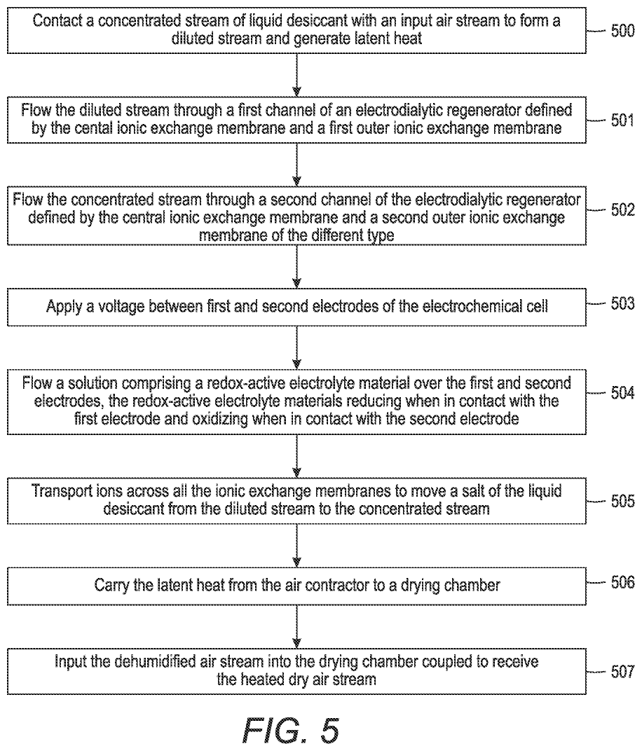

In FIG. 5, a flow diagram shows a method according to an example embodiment. The method involves contacting 500 a concentrated stream of liquid desiccant with an input air stream in an air contactor. The concentrated stream is diluted via absorption of water from the input air stream to form a diluted stream of the liquid desiccant and a dehumidified air stream. The absorption of water generates latent heat. The diluted stream is flowed 501 through a first channel of an electrodialytic regenerator. The first channel is defined by a central ionic exchange membrane and a first outer ionic exchange membrane of a different type than the central ionic exchange membrane. The concentrated stream is flowed 502 through a second channel of the electrodialytic regenerator. The second channel is defined by the central ionic exchange membrane and a second outer ionic exchange membrane of the different type.

An external voltage is applied 503 between first and second electrodes of the electrodialytic regenerator. One or more solutions with one or more redox-active electrolyte materials are flowed 504 over the first and second electrodes. The redox-active electrolyte materials reduce when in contact with, e.g., the first electrode and oxidize when in contact with e.g., the second electrode. Note that the second electrode may cause reduction and the first electrode may cause oxidation in some embodiments. In response to reduction and oxidation of the redox-active electrolyte materials, ions are transported 505 across the first outer, second outer, and central ionic exchange membranes to move a salt of the liquid desiccant from the first channel to the second channel. The latent heat is carried 506 from the air contactor to a drying chamber, and the dehumidified air stream is input into the drying chamber coupled to receive the heated dry air stream.

In summary, systems and methods are described that can reduce energy consumption in electrochemically regenerated dehumidification and air conditioning systems, extend system performance, and enable co-located sensible heating and cooling with separate control. In one embodiment, a secondary heat pump is used to adjust the operating conditions of an electrochemically regenerated liquid desiccant system. An electrochemically regenerated liquid desiccant dehumidifier has at least one air contactor for dehumidifying air where a secondary heat pump system is utilized to control the water vapor absorption temperature, the regeneration temperature or a combination of both. The regeneration temperature can be controlled directly in the regenerator, in one or more air contactors used for humidification, or a combination of both.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g., 1 to 5 includes 1, 1.5, 2, 2.75, 3, 3.80, 4, and 5) and any range within that range. All descriptions of solute concentrations by percentage are meant to describe percentage by weight unless otherwise indicated.

The foregoing description has been presented for the purposes of illustration and description. It is not intended to be exhaustive or to limit the embodiments to the precise form disclosed. Many modifications and variations are possible in light of the above teachings. Any or all features of the disclosed embodiments can be applied individually or in any combination and are not meant to be limiting, but purely illustrative. It is intended that the scope of the invention be limited not with this detailed description, but rather, determined by the claims appended hereto.

What is claimed is:

1. A dryer system comprising:
an electrodialytic regenerator comprising:
a first channel that dilutes a first stream of liquid desiccant and a second channel that concentrates a second stream of the liquid desiccant, the first and second channels separated by a central ionic exchange membrane;
a redox shuttle loop with first and second redox streams separated from the first and second channels by respective first and second outer ionic exchange membranes of a different type than the central ionic exchange membrane; and
first and second electrodes that are operable to apply a voltage across the electrodialytic regenerator and cause the dilution of the first stream and the concentration of the second stream;
an air-liquid interface in fluid communication with the second stream of the liquid desiccant and an input air stream, the air-liquid interface exposing the second stream of the liquid desiccant to the input air stream, absorption of water from the input air stream by the second stream creating a dehumidified air stream;
a heat transfer element in thermal communication with the air-liquid interface, the heat transfer element carrying latent heat generated from the absorption of the water from the input air stream; and
a drying chamber coupled to receive the dehumidified air stream and the heat.

2. The dryer system of claim 1, wherein the second stream is diluted via absorption of water from the input air stream to form a diluted stream, the diluted stream being circulated back the electrodialytic regenerator to be reconcentrated.

3. The dryer system of claim 1, further comprising a thermal mass receiving the heat from the heat transfer element, the thermal mass storing heat energy when the dryer system is idle and releasing the stored heat energy to the drying chamber during a drying operation of the dryer system.

4. The dryer system of claim 1, wherein a dryer output air stream is received from the drying chamber and used to form at least part of the input air stream.

5. The dryer system of claim 1, wherein the input air stream comprises ambient air, and wherein a dryer output air stream from the drying chamber is released to an atmosphere.

6. The dryer system of claim 1, wherein a dryer output air stream is received from the drying chamber, the dryer system further comprising a heat exchanger that extracts heat from the dryer output air stream and directed to the electrodialytic regenerator.

7. The dryer system of claim 1, further comprising a second air-liquid interface in fluid communication with a diluted discharge stream of the electrodialytic regenerator, the diluted discharge stream having a <10% concentration of the liquid desiccant, the second air-liquid interface exposing the diluted discharge stream to a second air flow, the diluted discharge stream being concentrated via evaporation of the water into the second air flow to form a concentrated stream of the liquid desiccant, the concentrated stream being circulated back into the electrodialytic regenerator.

8. The dryer system of claim 1, further comprising a source of additional heat that is input to the drying chamber with the dehumidified air stream and the heat.

9. The dryer system of claim 1, wherein the electrodialytic regenerator is a first electrodialytic regenerator, the system further comprising a second electrodialytic regenerator comprising:
a third channel that dilutes a third stream of the liquid desiccant and a fourth channel that concentrates a fourth stream of the liquid desiccant, the third and fourth channels separated by a second central ionic exchange membrane;
a second redox shuttle loop with third and fourth redox streams separated from the third and fourth channels by respective third and fourth outer ionic exchange membranes of a second different type than the second central ionic exchange membrane; and
third and fourth electrodes that are operable to apply a second voltage across the second electrodialytic regenerator and cause the dilution of the third stream and the concentration of the fourth stream; and
wherein the first stream from the first electrodialytic regenerator forms at least part of the third stream and wherein the fourth stream forms at least part of the second stream of the first electrodialytic regenerator.

10. The dryer system of claim 1, wherein first and second redox stream comprise a ferrocene derivative or ferrocyanide/ferricyanide, and wherein the liquid desiccant comprises LiCl.

11. A method, comprising:
applying an external voltage between first and second electrodes of an electrodialytic regenerator comprising first and second channels separated by a central ionic exchange membrane, the first and second electrodes being separated from the first and second channels by respective first and second outer ionic exchange membranes of a different type than the central ionic exchange membrane;
flowing one or more solutions comprising one or more redox-active electrolyte materials over the first and second electrodes, wherein the redox-active electrolyte materials reduce when in contact with the one of the first and second electrodes and oxidize when in contact with another of the first and second electrodes;
in response to reduction and oxidation of the redox-active electrolyte materials, transporting ions across the first outer, second outer, and central ionic exchange membranes to move a salt of a liquid desiccant from the first channel to the second channel, the second channel producing a concentrated stream of the liquid desiccant;
contacting the concentrated stream with an input air stream in an air contactor, the concentrated stream absorbing of water from the input air stream to form a dehumidified air stream, the absorbing of water generating latent heat;
carrying the latent heat from the air contactor to a drying chamber; and
inputting the dehumidified air stream into the drying chamber.

12. The method of claim 11, wherein the absorbing of water from the input air stream by the concentrated stream forms a diluted stream of the liquid desiccant, the method further comprising circulating the diluted stream back the electrodialytic regenerator to be reconcentrated.

13. The method of claim 11, wherein the latent heat is carried from the air contactor to the drying chamber via a thermal mass that stores heat energy.

14. The method of claim 13, further comprising:
storing the heat energy in the thermal mass when the drying chamber is idle; and
releasing the stored heat energy to the drying chamber during a drying operation.

15. The method of claim 11, further comprising:
receiving a dryer output air stream from the drying chamber; and
using the dryer output stream to form at least part of the input air stream.

16. The method of claim 11, further comprising releasing a dryer output air stream from the drying chamber to an atmosphere.

17. The method of claim 11, further comprising:
extracting heat from dryer output air stream from the drying chamber; and
directing the heat to the electrodialytic regenerator.

18. The method of claim 11, wherein a second air-liquid interface is in fluid communication with a diluted discharge stream of the liquid desiccant, the method further comprising:
exposing the diluted stream of the liquid desiccant to a second air flow at the second air-liquid interface, the diluted stream being concentrated via evaporation of the water into the second air flow to form a second concentrated stream of the liquid desiccant; and
circulating the second concentrated stream back into the electrodialytic regenerator.

19. The method of claim 11, wherein the redox-active electrolyte materials comprise a ferrocene derivative or ferrocyanide/ferricyanide, and wherein the liquid desiccant comprises LiCl.
